(19) United States
(12) Patent Application Publication
(10) Pub. No.: US 2005/0188136 A1
(43) Pub. Date: Aug. 25, 2005

(54) Computer product, communication control method, and communication control device

(75) Inventor: Yutaro Ishikawa, Saitama (JP)

Correspondence Address: FOLEY AND LARDNER;SUITE 500, 3000 K STREET NW, WASHINGTON, DC, 20007, US

(73) Assignee: PIONEER CORPORATION

(21) Appl. No.: 11/048,770

(22) Filed: Feb. 3, 2005

(30) Foreign Application Priority Data
Feb. 19, 2004 (JP) 2004-043011

(51) Int. Cl. G06F 13/42

(52) U.S. Cl. 710/106; 710/305

(57) ABSTRACT

As a pre-process step in a transmission process of a communication program in a universal asynchronous receiver transmitter (UART) communication, a communication control program causes a data output terminal of a device on a transmission side to change its level from “L” (low level) to “H” (high level), which shifts a device on a reception side from a standby state to a reception-wait state. As a post-process in the transmission process, when transmission of data is finished, the communication control program causes the data output terminal to change its level from “H” to “L” corresponding to an idle state defined by the Inter Equipment Bus (IE Bus).

### BACKGROUND OF THE INVENTION

1) Field of the Invention

The present invention relates to a technology for performing communications between a plurality of devices.

2) Description of the Related Art

Local area networks used in vehicles (hereinafter, “onboard LAN”) are generally divided into a body system, a power train system, a safety system, and an information system. The respective systems use communication protocols suitable for their purposes.

The body system includes switches, arrangements for turning on/off lights, and arrangements for opening/closing doors. The power train system includes the engine, the transmission system, and the brake system. The safety system includes air bag-system and collision sensors. The information system includes the car navigation system and car audio system. The information system uses arrangements that can perform high-speed communications to handle audio data and image data. To achieve high-speed communications, one approach is to use communication protocols such as Inter Equipment Bus (IE Bus™), Media Oriented System Transport (MOST), and Domestic Digital Bus/Optical (D2B/Optical).

FIG. 6 is a block diagram of a hardware configuration of a conventional onboard LAN that uses the IE Bus. The onboard LAN includes a plurality of devices 10 and 12. The devices 10 and 12, can be, for example a compact disk (CD) player, a CD changer, a speaker, a video tuner, or a display. The onboard LAN also includes bus drivers 20 and 22, and a plurality of pull-down resistors R.

The device 10 has a communication function based on the IE Bus and an original function. For example, if the device 10 is a CD player, the original function is to reproduce a CD. The device 10 changes a voltage at a data output terminal Tx to a low level (hereinafter, “L”) or to a high level (hereinafter, “H”) and transmits desired data. The device 10 identifies whether a voltage input to a data input terminal Rx is “L” or “H,” and receives the data. The communication function based on the IE Bus of the device 12 is the same as that of the device 10, although the original function may be different.

The bus drivers 20 and 22 perform the same function. The bus driver 20 functions as an interface for the IE Bus. The IE Bus is a differential bus, and therefore, the bus driver 20 converts data input through a data input terminal SI to a differential signal and outputs the differential signal to differential input-output terminals BUS+ and BUS−. Moreover, the bus driver 20 receives data according to a differential signal input to the differential input-output terminals BUS+ and BUS−, changes the level of a data output terminal SO to “L” or “H”, and outputs the data. That is, the bus driver 20 performs a drive process of converting the signal input through the data input terminal SI to a differential signal and outputting the differential signal to the differential input-output terminals BUS+ and BUS−. The bus driver 20 also performs a reception process of receiving the differential signal input through the differential input-output terminals BUS+ and BUS−, converting the differential signal received to a voltage signal, and outputting the voltage signal to the data output terminal SO.

FIG. 7 is a conceptual diagram for explaining data transmission from the device 12 to the device 10. Asignal 30, corresponding to transmission data output from the data output terminal Tx of the device 12, is input to the data input terminal Si of the bus driver 22. The bus driver 22 subjects the signal 30 to the drive process to convert it to a differential signal 31, and outputs the differential signal 31 from the differential input-output terminals BUS+ and BUS−.

The bus driver.20 subjects the differential signal 31 input through the differential input-output terminals BUS+ and BUS− to the reception process to convert it to a voltage signal 32, and outputs the voltage signal 32 from the data output terminal SO. The device 10 receives the voltage signal 32 input to the data input terminal Rx.

The IE Bus performs access control using a Carrier Sense Multiple Access with Collision Detection (CSMA/CD) method. In other words, the bus driver 22 receives the signal 30 from the device 12, subjects the signal 30 to the drive process to convert it to the differential signal 31, and outputs the differential signal 31 to the differential input-output terminals BUS+ and BUS−. The bus driver 22 also subjects the signal input to the differential input-output terminals BUS+ and BUS− to the reception process to convert it to the voltage signal 33, and outputs the voltage signal 33 from the data output terminal SO. The device 12 performs collision detection based on the voltage signal 33 input and the outputted signal 30, and determines whether the data has been transmitted.

Generally, the operation of collision detection is used to determine whether data echoed-back coincides with data transmitted by the device itself. Therefore, it is required to fix the data output terminal Tx of a device that does not transmit data. In the IE Bus, when the data is not transmitted, it is defined so that the level of the data output terminal Tx is fixed to “L.”

On the other hand, in personal computers, communication is conventionally carried out using a Universal Asynchronous Receiver Transmitter (UART) system. Therefore, many personal computers include built-in UART hardware and software (communication program). Therefore, the hardware for UART communications may be configured as follows. As shown in FIG. 8, the data output terminal Tx of a device 14 and the data input terminal Rx of a device 16 may be connected through a transmission medium 41, and the data output terminal Tx of the device 16 and the data input terminal Rx of the device 14 may be connected through a transmission medium 40.

The operations of the onboard LAN when the data is transmitted from the device 16 to the device 14 are explained below with reference to the flowcharts of FIG. 9 and FIG. 10A to FIG. 10D. The communication program includes a transmission process and a reception process. The operation of the transmission process is explained using the device 16 on the transmission side, and the operation of the reception process is explained using the device 14 on the reception side. In the initial state, as shown in FIG. 10A, the device 16 is in an idle state (which is a state in which no data is transmitted), and the level of the data output terminal Tx is fixed to “H.” The device 14 is in a reception-wait state.

When there is data to be transmitted (step S100), the communication program for the device 16 changes the level of the data output terminal Tx to “L” (step S110). The communication program for the device 14 being in the reception-wait state continuously monitors the state of the data input terminal Rx. When detecting that the data input terminal Rx has changed from “H” to “L” (step S200), the communication program for the device 14 activates a hardware relating to the UART communication included in the device 14 and starts receiving-data (step S210). Precisely, the hardware includes a timer that measures a time at a preset communication rate to identify a state of the data input terminal Rx. In other words, as shown in FIG. 10B, a state of the device 16 changes from the idle state to a transmission-ready state, and changes the level of the data output terminal Tx to “L” to cause a state of the device 14 to change from the reception-wait state to a reception-ready state.

If the transmission data is a logical 0 (hereinafter, “0”), the communication program for the device 16 changes the level of the data output terminal Tx to “L.” Moreover, if the transmission data is a logical 1 (hereinafter, “1”), the communication program for the device 16 changes the level of the data output terminal Tx to “H.” The transmission of the data (step S120) is repeated until there is no data for the transmission (step S130).

On the other hand, the communication program for the device 14 identifies whether the data input terminal Rx is in “H” or in “L” based on the predetermined communication rate, and repeats the reception of the data (step S220) until the reception of data in command units or packet units is finished (step S230). As shown in FIG. 10C, when the device 16 transmits 8-bit data “10100110” from the data output terminal Tx, the device 14 identifies whether the data input terminal Rx is in “H” or in “L” and receives the data “10100110”.

When there is no more data for transmitting, the communication program for the device 16 changes the level of the data output terminal Tx to “H” (step S140). On the other hand, when all the data has been received, the communication program for the device 14 stops the hardware relating to the UART communication and terminates the reception of the data (step S240). In other words, as shown in FIG. 10D, the device 16 shifts from the transmission-ready state to the idle state and changes the level of the data output terminal Tx to “H,” and the device 14 shifts from the reception-ready state to the reception-wait state.

As explained above, the communication program for the UART communication sets the level of the data output terminal Tx to “H” when data is not transmitted, and changes the level of the data output terminal Tx from “H” to “L” when data is to be transmitted and notifies the device on the reception side that communication is going to start. In other words, the communication program sets the level of the data output terminal Tx to “H” to shift the device on the transmission side into an idle state and sets the level of the data output terminal Rx to “H” to shift the device on the transmission side into a transmission-ready state.

As explained above, in the UART communication, a device in the idle state sets the level of the data output terminal to “H,” whereas in the IE Bus, a device in the idle state has to set the level of the data output terminal to “L.” In other words, the UART communication and the IE Bus have mutually contradictory characteristics in the idle state. Therefore, car audio equipment, such as a CD cassette recorder and a CD changer, connected to the onboard LAN using the IE Bus cannot be connected to a personal computer. As a result, when any failure occurs in the car audio equipment, the defect cannot be checked using a personal computer; on the other hand, it becomes necessary to disassemble the equipment and check it using a stylus-type measuring device.

One approach to solve this problem is to provide two separate interfaces in the car audio equipment; one for the UART communication and the other for communication through the IE Bus. However, there are only two terminals for physical connection to the IE Bus; the data output terminal for transmission and the data input terminal for reception. In other words, there are no terminals for the signals to control two more communication signals. If two types of independent hardware and software are provided, it leads to an increase in the number of components and also and also leads to an increase in the amount of memory needed to store the applicable software. Thus, the cost of the equipment inevitably increases. Furthermore, since the places where the car audio equipment is installed are restricted, there are limitations on its size; therefore, the two types of hardware are difficult to install due to spatial constraints.

### SUMMARY OF THE INVENTION

It is an object of the present invention to solve at least the problems in the conventional technology.

A method according to an aspect of the present invention is a method for performing a communication process among a plurality of devices including a first device and a second device connected to a bus. The method includes changing a data output terminal of the first device to a first polarity different from a second polarity, which is defined by the bus as an idle state of the first device, if there is data to be transmitted from the first device to the second device; and transmitting the data from the first device to the second device after changing the data output terminal of the first device back to the second polarity.

A according to another aspect of the present invention is method for performing a communication process among a plurality of devices including a first device and a second device that perform communication to a bus through an auxiliary device, the devices performing communication using the communication process, wherein the first device is an idle state when a transmission control terminal of the first device is set to a first polarity and a data output terminal of the first device is set to a second polarity different from the first polarity. The method includes changing the transmission control terminal from the first polarity to the second polarity if there is data to be transmitted from the first device to the second device; turning on a transistor in the auxiliary device in response to the change of the transmission control terminal; and transmitting the data from the first device to the second device via the transistor in the auxiliary device after changing the data output terminal of the first device from the second polarity to the first polarity.

A communication control device according to still another aspect of the present invention performs a communication process among a plurality of devices including a first device and a second device connected to a bus. The communication control device includes a polarity changing unit that changes a data output terminal of the first device to a first polarity different from a second polarity, which is defined by the bus as an idle state of the first device, if there is data to be transmitted from the first device to the second device; and a transmitting unit that transmits the data from the first device to the second device after changing the data output terminal of the first device back to the second polarity.

A communication control device according to still another aspect of the present invention performs a communication process among a plurality of devices including a first device and a second device that perform communication to a bus through an auxiliary device, the devices performing communication using the communication process, wherein the first device is an idle state when a transmission control terminal of the first device is set to a first polarity and a data output terminal of the first device is set to a second polarity different from the first polarity. The communication control device includes a polarity changing unit that changes the transmission control terminal from the first polarity to the second polarity if there is data to be transmitted from the first device to the second device; a transistor controlling unit that turns on a transistor in the auxiliary device in response to the change of the transmission control terminal; and a transmitting unit that transmits the data from the first device to the second device via the transistor in the auxiliary device after changing the data output terminal of the first device from the second polarity to the first polarity.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a flowchart of a communication control method according to a first embodiment of the present invention;

FIGS. 2A to 2F are schematic diagrams for explaining the communication control method according to the first embodiment;

FIG. 3 is a block diagram of an exemplary configuration of a communication control device according to a second embodiment of the present invention;

FIG. 4 is a block diagram of another exemplary configuration of a communication control device according to the second embodiment;

FIG. 5 is a flowchart of a communication control method according to the second embodiment;

FIG. 6 is a block diagram of a conventional onboard LAN;

FIG. 7 is a diagram for explaining data transmission performed by the conventional onboard LAN shown in FIG. 6;

FIG. 8 is a schematic diagram for explaining connections between devices that perform conventional UART communication;

FIG. 9 is a flowchart of a communication control method based on the conventional UART communication; and

FIGS. 10A to 10D are schematic diagrams for explaining the operation of a conventional communication control program.

### DETAILED DESCRIPTION

Exemplary embodiments of a computer product, a communication control method, and a communication control device according to the present invention are explained in detail below with reference to the accompanying drawings.

The communication process according to the present invention includes a standby state—a state in which a device does not perform data reception, and a reception-request state—a state that is between an idle state and a transmission-ready state. Precisely, the reception-request state is a state in which a reception request is sent so as to cause a reception-side device to shift from a standby state to a reception-wait state.

The present invention includes setting a level of the data output terminal to “L” in the idle state as defined by the IE Bus, and changing the level to “H” in the reception-request state to cause the reception-side device to shift from the standby state to the reception-wait state. Subsequently, the communication control program shifts from the reception-request state to the reception-ready state, changes the level of the data output terminal to “L” to cause the reception-side device to shift from the reception-wait state to the reception-ready state, and transmits the data.

As a result, according to the present invention, it becomes-possible to perform the UART communication in the IE Bus simply by applying minor changes to the conventional software for the UART communication. The changes include adding two steps in the conventional software. A first step includes changing the level of the data output terminal from “L” to “H” to cause the reception-side device to shift from the standby state to the reception-wait state. The first step serves as a pre-process in the transmission process of a communication program in the conventional UART communication. A second step includes changing the level of the data output terminal from “H” to “L” for the idle state defined by the IE Bus. The second step serves as a post-process in the transmission process of the communication program in the conventional UART communication.

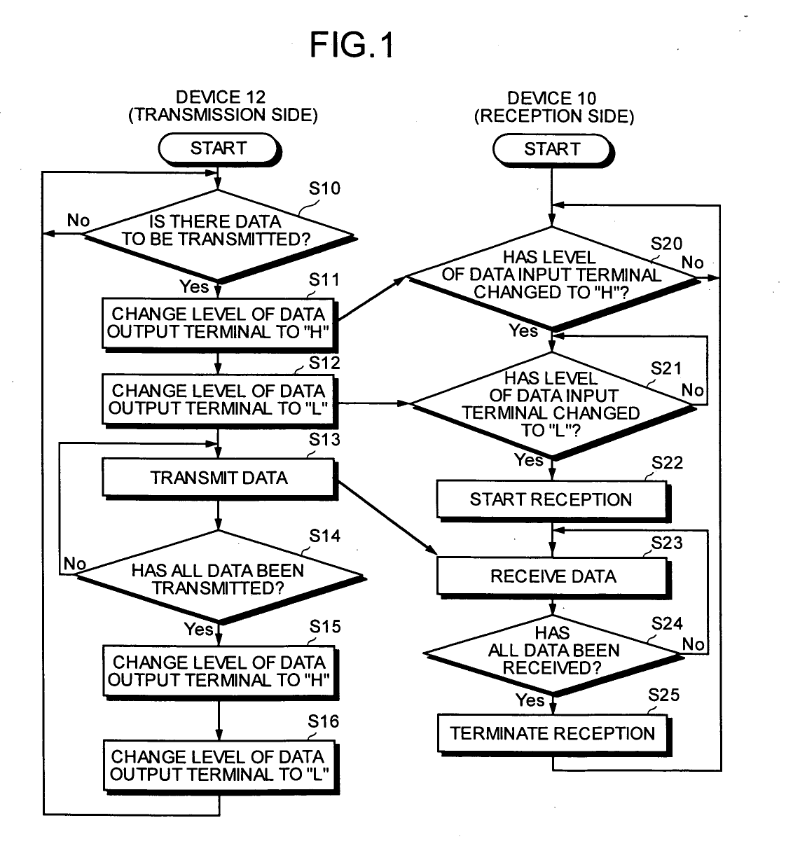

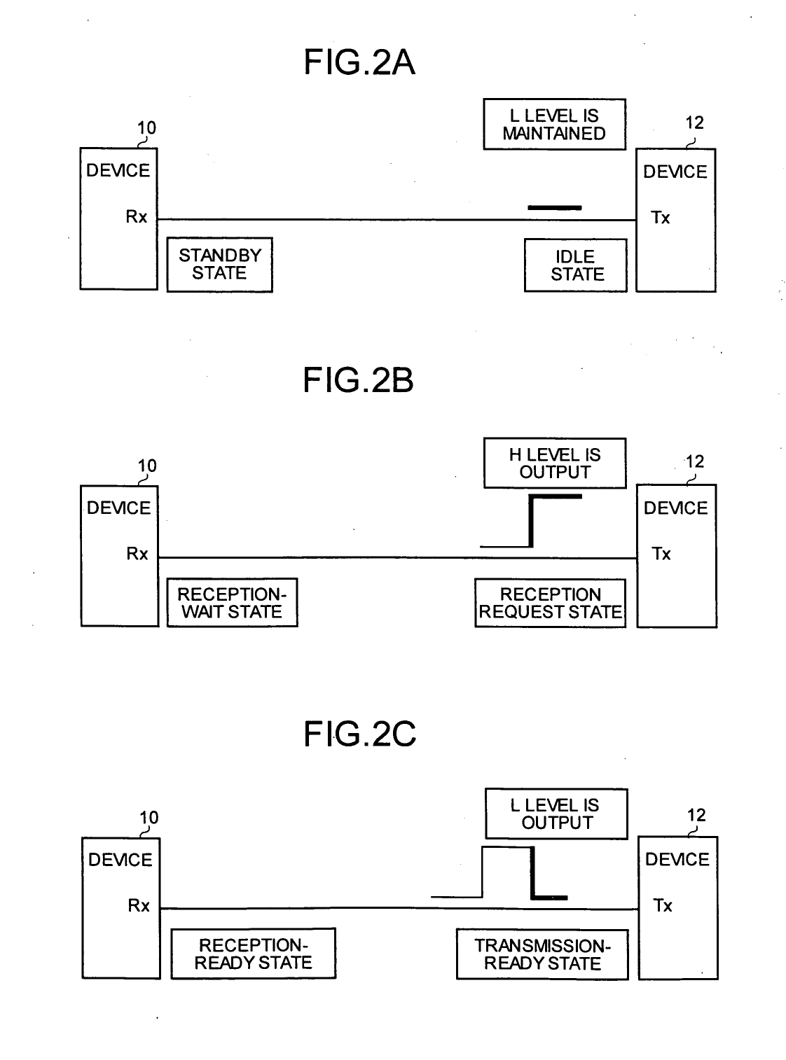

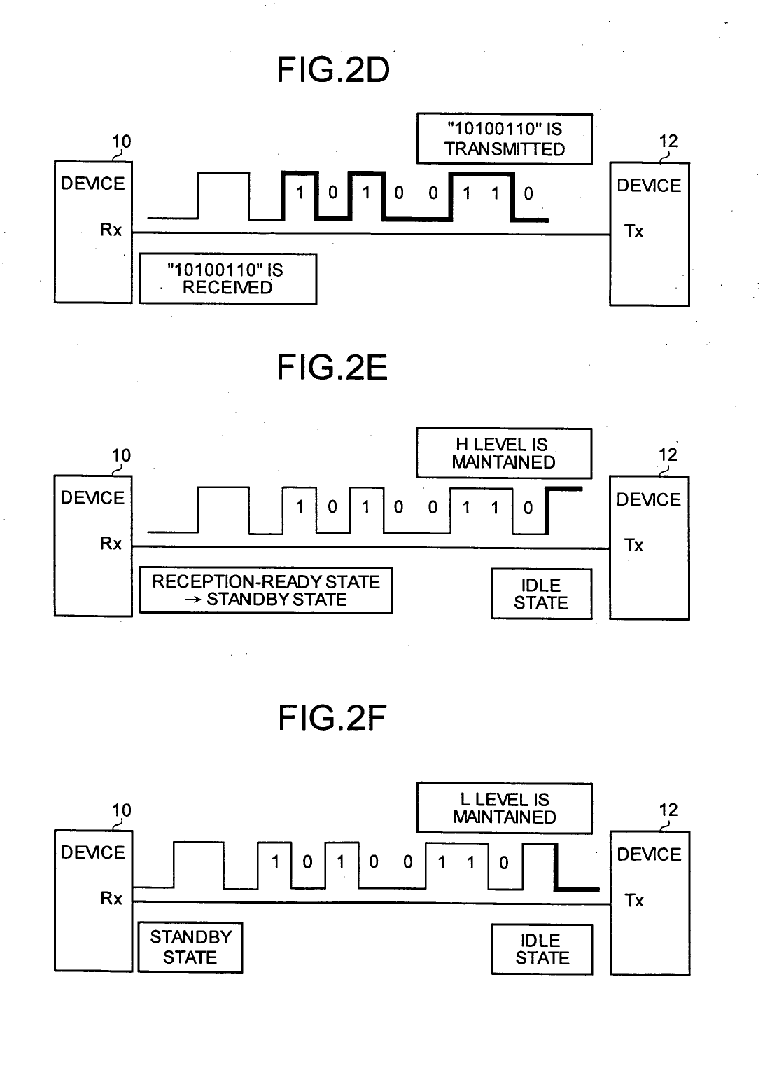

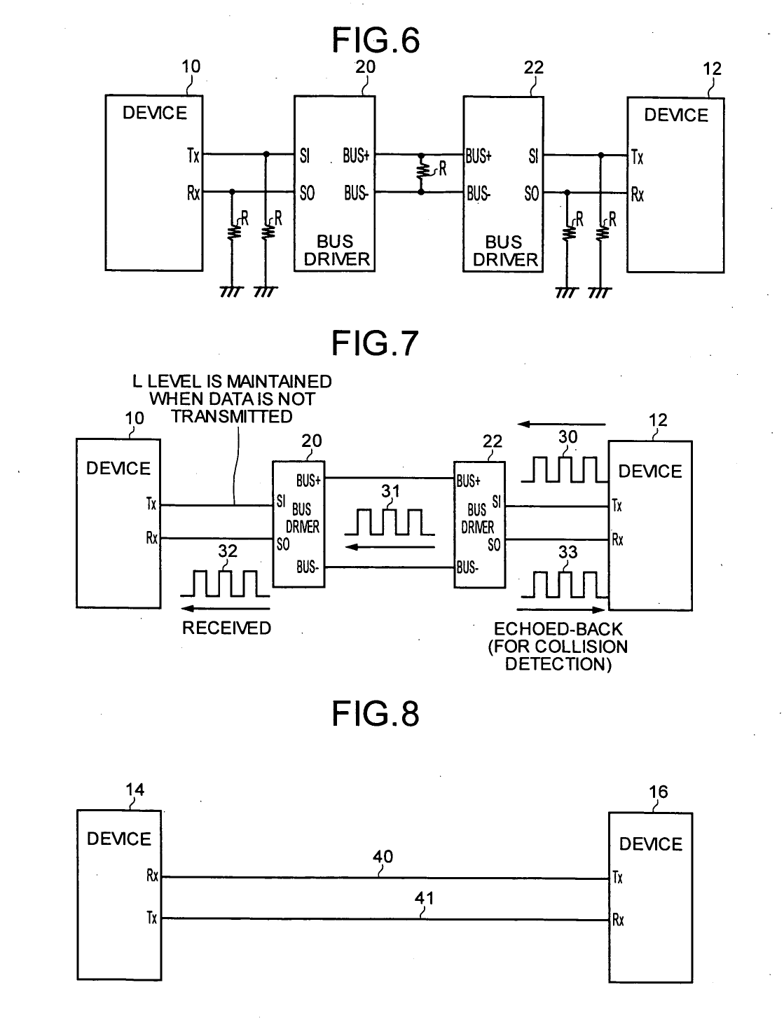

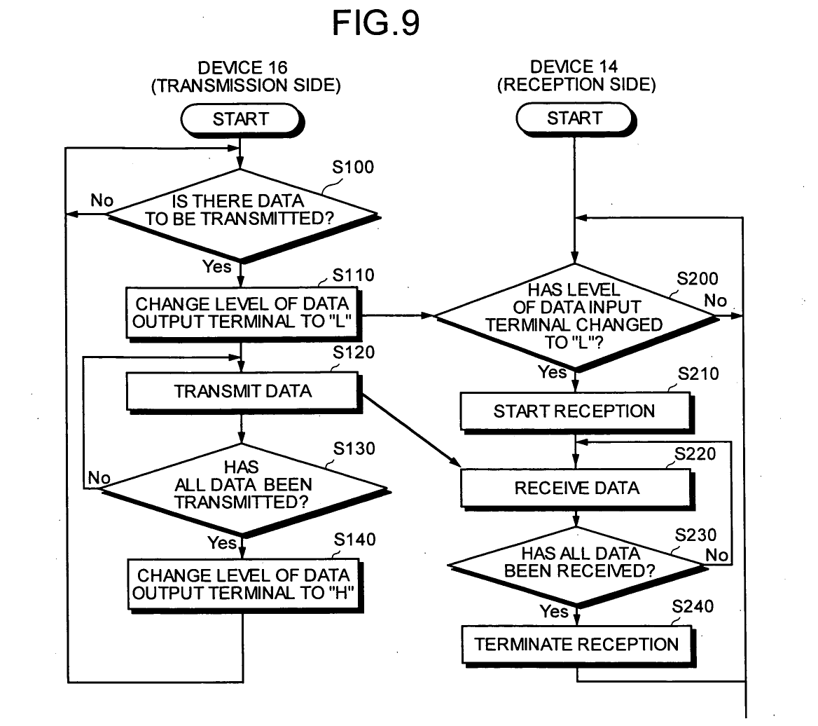

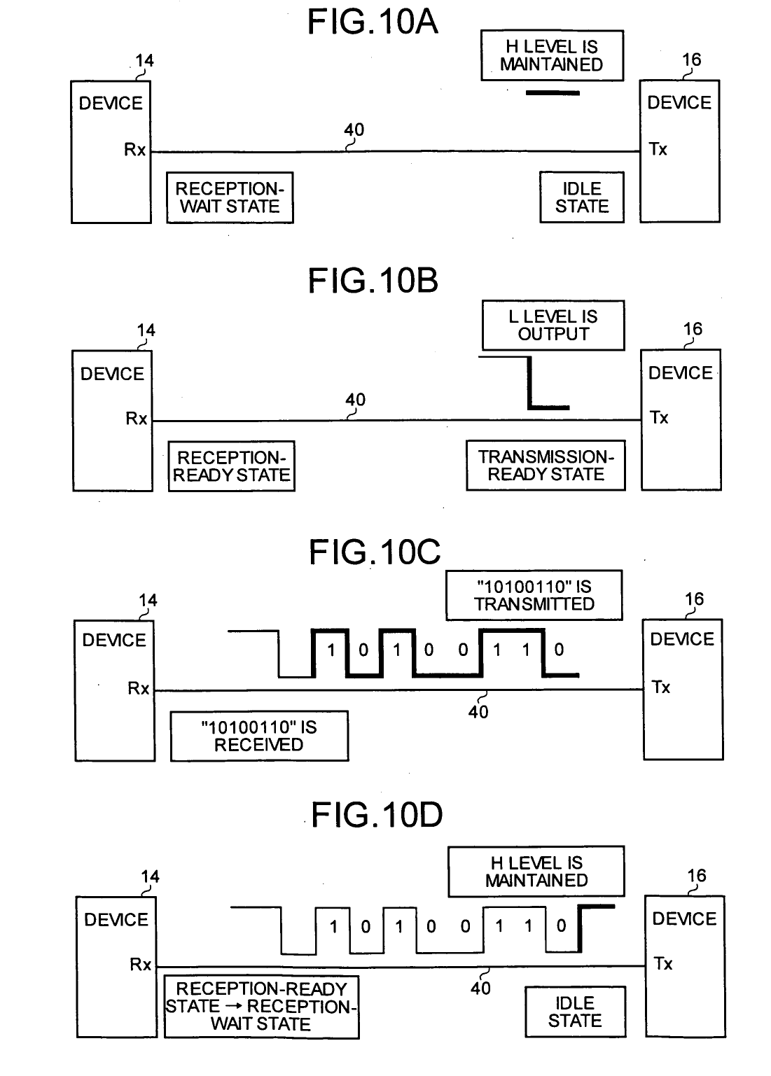

A first embodiment of the present invention is explained below with reference to FIG. 1 and FIG. 2A through FIG. 2F. The configuration of hardware according to the first embodiment is the same as that of the conventional onboard LAN using the IE Bus (see FIG. 6), and therefore, explanation thereof is omitted.

The method and a computer program for realizing the method on a computer according to the first embodiment are explained with reference to FIG. 1 and FIG. 2A to FIG. 2F. It is assumed here that data is transmitted from the device 12 to the device 10 (see FIG. 2A). The method according to the first embodiment includes the transmission process and the reception process. The operation of the transmission process is explained using the device 12 on the transmission side, and the operation of the reception process is explained using the device 10 on the reception side. In their initial states, as shown in FIG. 2A, the device 12 on the transmission side is in an idle state, the level of the data output terminal Tx is fixed to “L,” and the device 10 on the reception side is in a standby state.

A communication control program for the device 12 determines if there is any data to be transmitted (step S10), and if so, changes the level of the data output terminal Tx to “H” (step S11). On the other hand, a communication control program for the device 10 continuously monitors the state of a data input terminal Rx while the device 10 is in the standby state. If it detects the change in the level of the data input terminal Rx from “L” to “H,” then the communication control program for the device 10 shifts the state of the device 10 from the standby state to a reception-wait state and continues to monitor the state of the data input terminal Rx (step S20). In other words, as shown in FIG. 2B, the device 12 shifts from the idle state to the reception-request state to change the level of the data output terminal Tx to “H,” which causes the device 10 to shift from the standby state to the reception-wait state.

The communication control program for the device 12, after the reception-side device 10 shifts from the standby state to the reception-wait state, changes the level of the data output terminal Tx to “L” (step S12). If the communication control program for the device 10 detects that the level of the data input terminal Rx has changed from “H” to “L” (step S21), then the communication control program for the device 10 activates hardware relating to the UART communication in the device 10 and starts receiving data from the device 12 (step S22). This hardware includes a timer that measures a time at a preset communication rate to identify a state of the data input terminal Rx. In other words, as shown in FIG. 2C, the device 12 shifts from the reception-request state to a transmission-ready state by changing the level of the data output terminal Tx to “L;” this causes the device 10 to shift from the reception-wait state to the reception-ready state.

For example, the communication control program for the device 12 changes the level of the data output terminal Tx to “L” if the transmission data is “0,” and changes the level to “H” if the transmission data is “1.” The communication control program for the device 12 repeats the operation of transmitting data (step S13) until there is no more data that is to be transmitted (step S14).

On the other hand, the communication control program for the device 10 identifies whether the data input terminal Rx is “H” or “L” based on the preset communication rate and repeats the operation of receiving the data (step S23) until there is no more data that is to be received (step S24). As shown in FIG. 2D, when the device 12 transmits 8-bit transmission data of “10100110” from the data output terminal Tx, the device 10 identifies whether the data input terminal Rx is “H” or “L” and receives “10100110.”

When there is no more data that is to transmitted, the communication control program for the device 12 changes the level of the data output terminal Tx to “H” (step S15). On the other hand, the communication control program for the device 10 receives all the data, stops the hardware relating to the UART communication, and then terminates the reception of the data (step S25). As shown in FIG. 2E, the device 12 shifts from the transmission-ready state to the idle state so that the level of the data output terminal Tx changes to “H.” and the device 10 shifts from the reception-ready state to the standby state.

The communication control program for the device 12 changes the level of the data output terminal Tx to “L” after a predetermined time (step S1 6). In other words, as shown in FIG. 2F, the device 12 fixes the level of the data output terminal Tx to “L” and enters into the idle state as defined by the IE Bus.

In the first embodiment, by applying the minor change, i.e., the addition of two steps, to the computer program as the pre-process in the transmission process of the communication program in the conventional UART communication, the UART communication can be implemented in the IE Bus without providing the two corresponding pieces of hardware. In other words, it is impossible to avoid using hardware for the UART communication, which makes it possible to prevent an increase in the number of components and to perform the UART communication on the IE Bus without an increase in cost of the devices.

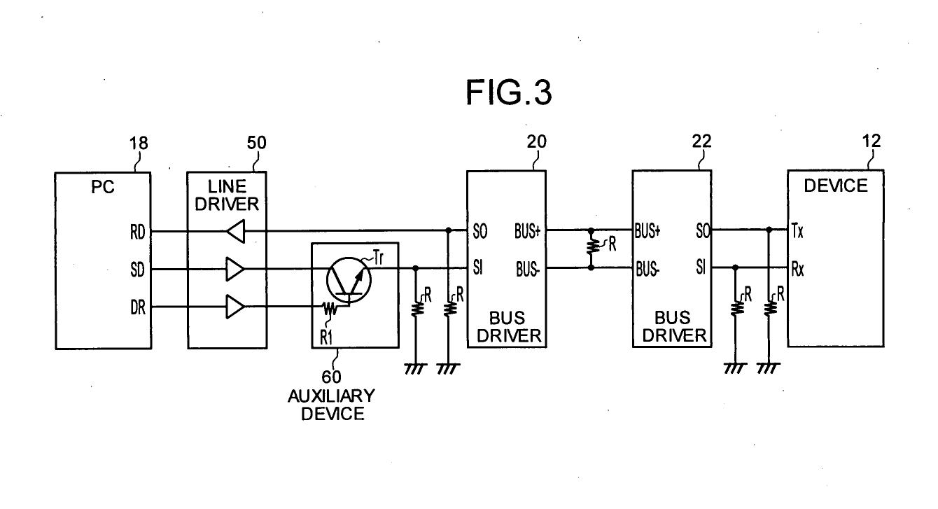

A method and a computer program according to a second embodiment of the present invention are explained with reference to FIG. 3 to FIG. 5. In the first embodiment, the data output terminal of the device connected to the IE Bus is controlled to perform UART communication. However, personal computers, their peripheral devices, and consumer appliances typically use the TIA/EIA-232-E standard (generally, RS-232) and perform communications using an RS-232 driver program. As a result, it can be difficult to freely control the data output terminal. To address this difficulty, in the second embodiment, an auxiliary device is provided between a data output terminal and a bus driver. The auxiliary device is controlled to connect a device based on the RS-232 standard to the IE Bus and to perform UART communication.

FIG. 3 is a block diagram of an exemplary hardware according to the second embodiment. This hardware includes a personal computer (hereinafter, “PC”) 18 instead of the device 10. The PC 18 is connected to a bus driver 20 through an RS-232 line driver 50 and an auxiliary device 60. The components having the same functions as these in the hardware as shown in FIG. 6 are assigned with the same reference signs, and explanation thereof is omitted to avoid simple repetition of explanation.

The PC 18 has an input terminal based on the RS-232 . The RS-232 covers 9 pins and 25 pins, but generally not all the terminals (pins) are used. A terminal (terminal controlled by a driver program) continuously used for communication includes a data output terminal SD that outputs a signal upon transmission and a data input terminal RD that receives a signal upon reception. In contrast, terminals for carrier detection and Data Set Delay are typically not used. A terminal that is not controlled by the driver program can be easily changed by a user. Therefore, the terminal for Data Set Delay can be configured as a transmission control terminal DR, although other terminals can be configured as the transmission control terminal DR.

A communication control program according to the second embodiment is installed on the PC 18. This communication control program controls the transmission control terminal DR to impleement UART communication (communication based on RS-232).

The auxiliary device 60 includes a transistor Tr and a resistor R1. The transistor Tr is turned on/off according to a control signal input from the transmission control terminal DR of the PC 18 through the line driver 50. That is, the transistor Tr outputs a signal input from the data output terminal through the line driver 50 to the data input terminal SI of the bus driver or disconnects the data output terminal from the IE Bus to change the level of the data input terminal SI of the, bus driver to “L.”

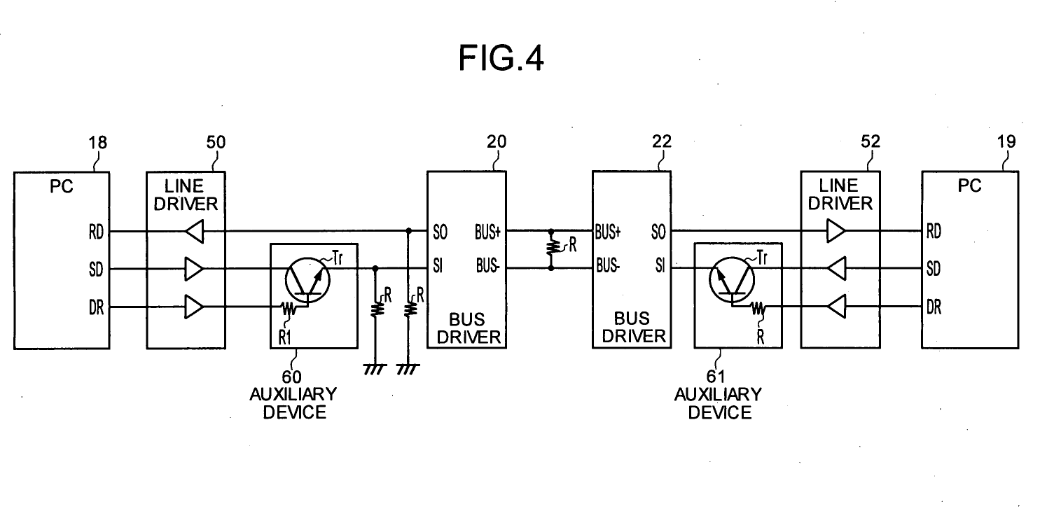

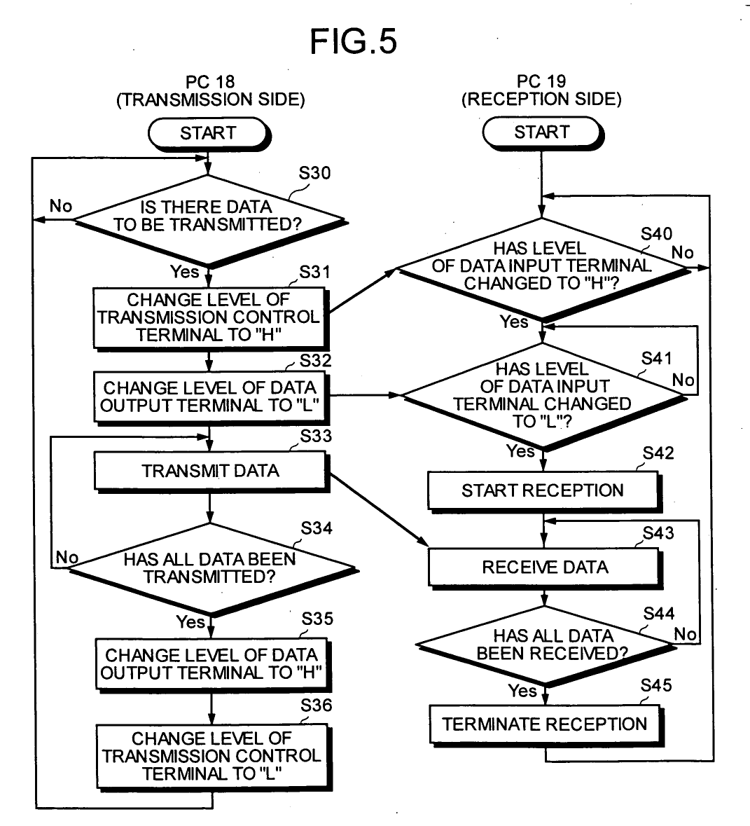

The operation of the communication control program according to the second embodiment is explained below with reference to FIG. 4 and the flowchart of FIG. 5. The hardware according to the second embodiment is configured generally as shown in FIG. 3. However, to explain the transmission process and the reception process of the communication control program according to the second embodiment concurrently, the hardware shown in FIG. 4 is employed. That is, the PC 18 is connected to the IE Bus through the line driver 50, the auxiliary device 60, and the bus driver 20, while a PC 19 is connected to the IE Bus through a line driver 52, an auxiliary device 61, and the bus driver 22.

The auxiliary device 61 has the same function as that of the auxiliary device 60. Moreover, the line driver 52 has the same function as that of the line driver 50. The method according to the second embodiment includes the transmission process and the reception process. The operation of the transmission process is explained using the PC 18 on the transmission side, while the operation of the reception process is explained using the PC 19 on the reception side.

In the initial state, the PC 18 is in the idle state, the level of the data output terminal SD is fixed to “H,” and the level of the transmission control terminal DR is fixed to “L.” Since the transmission control terminal DR of the PC 18 is “L,” the transistor Tr of the auxiliary device 60 is turned off, the signal “L” is input to the data input terminal SI of the bus driver 20, and the PC 19 is in the standby state.

A communication control program for the PC 18 shifts the PC 18 from the idle state to the reception-request state if there is data to be transmitted (step S30) and changes the level of the transmission control terminal DR to “H” (step S31). Consequently, the transistor Tr of the auxiliary device 60 is turned on, and the data input terminal SI of the bus driver 20 and the data output terminal SO of the PC 18 are connected to each other. The signal “H” is input to the data input terminal SI of the bus driver 20, and the level of the data input terminal RD of the PC 19 is changed to “H.”

In the standby state, the communication control program for the PC 19 continuously monitors the state of the data input terminal RD. If it detects that the level of the data input terminal RD has changed from “L” to “H,” then the communication control program for the PC 19 shifts from the standby state to the reception-wait state and continues to monitor the state of the data input terminal RD (step S40).

The communication control program for the PC 18, after the reception-side PC 19 shifts from the standby state to the reception-wait state, shifts from the reception-ready state to the transmission-ready state and changes the level of the data output terminal SD to “L” (step S32). If it detects that the level of the data input terminal RD has changed from “H” to “L” (step S41), then the communication control program for the PC 19 shifts from the reception-wait state to the reception-ready state, activates hardware relating to the UART communication in the PC 19, and starts receiving data (step S42). In this case, the hardware includes a timer that measures a time at a preset communication rate to identify a state of the data input terminal RD.

If the transmission data is “0,” the communication control program for the PC 18 changes the level of the data output terminal SD to “L” and changes it to “H” if the transmission data is “1.” The communication control program for the PC 18 repeats the operation of transmitting data until no data is transmitted (steps S33, S34).

On the other hand, the communication control program for the PC 19 identifies whether the data input terminal RD is “H” or “L” based on the preset communication rate and repeats the operation of receiving data (step S43) until the reception of data in command units or packet units is finished (step S44).

When no data is transmitted, the communication control program for the PC 1 8 shifts from the transmission-ready state to the idle state and changes the level of the data output terminal SD to “H” (step S35). On the other hand, the communication control program for the PC 19 receives all the data, stops the hardware relating to the UART communication, and finishes the reception (step S45). The communication control program for the PC 19 shifts to the standby state, and it is detected whether the level of the data input terminal RD has changed from “L” to “H.”

The communication control program for the PC 18 changes the level of the transmission control terminal DR to “L” after a predetermined time passes (step S36). Consequently, the transistor Tr of the auxiliary device 60 is turned off, the data output terminal SD of the PC 18 and the data input terminal SI of the bus driver 20 are disconnected, the signal “L” is input to the data input terminal SI of the bus driver 20, and the level of the data input terminal RD of the PC 19 is changed to “L.” In other words, the PC 18 returns to its initial state, which is the idle state, and the PC 19 returns to its initial state, which is the standby state.

In the second embodiment, a device based on the RS-232 standard is connected to an IE Bus through an auxiliary device. The auxiliary device connects the data output terminal of the device to the IE Bus when the control signal is negated (“H” in the second embodiment), disconnects it from the IE Bus when the control signal is asserted (“L” in the second embodiment), and outputs “L” to the IE Bus. The communication control program can implement the UART communication by connecting the device based on the RS-232 standard to the IE Bus simply by applying a minor change to the communication control program. The minor change is carried out by adding two steps as follows to the communication control program. One step is to negate the control signal that is output from the transmission control terminal to cause the reception-side device to shift from the standby state to the reception-wait state. This step serves as the pre-process in the transmission process of the driver software. The other step is to assert the control signal that is output from the transmission control terminal to output the polarity defined by the IE Bus to the IE Bus. This step serves as the post-process in the transmission process of the driver software.

According to the second embodiment, the data output terminal is not controlled but an RS-232 terminal reserved for future use is used as the transmission control terminal. Further, the auxiliary device is controlled by the transmission control terminal to implement the idle state of the IE Bus. As a result, the UART communication can be implemented by connecting the device based on the RS-232 standard to the IE Bus without any alteration of the conventional driver program.

Although a personal computer is taken up as an example of the device based on the RS-232 standard, the example is not so limited. For example, if a flash memory built-in microcomputer is used for a microcomputer that controls audio equipment, the communication control program according to the second embodiment can be included in a flash memory built-in microcomputer writer that writes data in the flash memory. The flash memory built-in microcomputer writer may be connected to the onboard LAN including the IE Bus using the auxiliary device. This configuration allows programs in the device to be altered without disassembly of the audio equipment.

Even if a failure occurs in the audio equipment, by incorporating the communication control program according to the second embodiment in a diagnosis monitor that monitors how the device works, the diagnosis monitor can be connected to the onboard LAN including the IE Bus using the auxiliary device. This allows the internal state of the device to be monitored when the failure occurs without disassembly of the audio equipment, which makes it possible to reduce the time for analysis on causes of the failure.

Furthermore, in the second embodiment, the auxiliary device is described as including the transistor and the resistor, but it is not so limited. Any device can be used for the auxiliary device if it can perform a function of switching between output of a signal from the data output terminal to the IE Bus and output of “L” thereto in accordance with the control signal.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer program product operable on a computer system configured to perform a communication process among a plurality of devices including a first device and a second device connected to a bus, the computer program product causing the computer system execute:
changing a data output terminal of the first device to a first polarity different from a second polarity, which is defined by the bus as an idle state of the first device, if there is data to be transmitted from the first device to the second device; and
transmitting the data from the first device to the second device after changing the data output terminal of the first device back to the second polarity.

2. The computer program product according to claim 1, wherein the bus is an Inter Equipment Bus and the second device activates a Universal Asynchronous Receiver Transmitter (UART) communication process.

3. A computer program product operable on a computer system configured to perform a communication process among a plurality of devices including a first device and a second device that perform communication to a bus through an auxiliary device, the devices performing communication using the communication process, wherein the first device is an idle state when a transmission control terminal of the first device is set to a first polarity and a data output terminal of the first device is set to a second polarity different from the first polarity, the computer program product causing the computer system execute:
changing the transmission control terminal from the first polarity to the second polarity if there is data to be transmitted from the first device to the second device;
turning on a transistor in the auxiliary device in response to the change of the transmission control terminal; and
transmitting the data from the first device to the second device via the transistor in the auxiliary device after changing the data output terminal of the first device from the second polarity to the first polarity.

4. The computer program product according to claim 2, wherein the bus is an Inter Equipment Bus and the second device activates a Universal Asynchronous Receiver Transmitter (UART) communication process.

5. A method for performing a communication process among a plurality of devices including a first device and a second device connected to a bus, the method comprising:
changing a data output terminal of the first device to a first polarity different from a second polarity, which is defined by the bus as an idle state of the first device, if there is data to be transmitted from the first device to the second device; and
transmitting the data from the first device to the second device after changing the data output terminal of the first device back to the second polarity.

6. The method according to claim 5, further comprising:
changing the data output terminal from the second polarity to the first polarity after the transmission of the data is complete; and
changing the data output terminal back to the first polarity to return the first device to the idle state.

7. The method according to claim 5, further comprising:
changing the first device from the idle state to a reception-request state after changing the data output terminal of the first device from the second polarity to the first polarity; and
changing the first device from the reception-request state to a transmission ready stated after changing the data output terminal of the first device back to the second polarity from the first polarity.

8. The method according to claim 5, further comprising:
detecting, by a data input terminal of the second device, the change of the data output terminal of the first device from the second polarity to the first polarity;
detecting, by the data input terminal of the second device, the change of the data output terminal of the first device back to the second polarity from the first polarity; and
receiving at the second device the data transmitted from the first device after detecting the change of the data output terminal of the first device back to the second polarity from the first polarity.

9. The method according to claim 5, wherein the bus is an Inter Equipment Bus.

10. A method for performing a communication process among a plurality of devices including a first device and a second device that perform communication to a bus through an auxiliary device, the devices performing communication using the communication process, wherein the first device is an idle state when a transmission control terminal of the first device is set to a first polarity and a data output terminal of the first device is set to a second polarity different from the first polarity, the method comprising:
changing the transmission control terminal from the first polarity to the second polarity if there is data to be transmitted from the first device to the second device;
turning on a transistor in the auxiliary device in response to the change of the transmission control terminal; and
transmitting the data from the first device to the second device via the transistor in the auxiliary device after changing the data output terminal of the first device from the second polarity to the first polarity.

11. The method according to claim 10, further comprising:
changing the data output terminal from the first polarity to the second polarity after the transmission of the data is complete; and
changing the transmission control terminal from the second polarity to the first polarity to return the first device to the idle state.

12. The method according to claim 10, further comprising:
changing the first device from the idle state to a reception-request state when there is data to be transmitted; and
changing the first device from the reception-request state to a transmission ready stated when the first device is ready to transmit the data.

13. The method according to claim 10, further comprising:
detecting, at the second device, the change of a data input terminal of the second device from the first polarity to the second polarity;
detecting, at the second device, the change of the data input terminal of the second device back to the first polarity from the second polarity; and
receiving at the second device the data transmitted from the first device after detecting the change of the data input terminal of the second device back to the first polarity from the second polarity.

14. The method according to claim 10, wherein the bus is an Inter Equipment Bus.

15. The method according to claim 10, wherein the data output terminal of the first device is coupled to the bus by the transistor in the auxiliary device, and
wherein the transistor is turned on or off in accordance with the polarity of the transmission control terminal.

16. A communication control device that performs a communication process among a plurality of devices including a first device and a second device connected to a bus, the communication control device comprising:
a polarity changing unit that changes a data output terminal of the first device to a first polarity different from a second polarity, which is defined by the bus as an idle state of the first device, if there is data to be transmitted from the first device to the second device; and
a transmitting unit that transmits the data from the first device to the second device after changing the data output terminal of the first device back to the second polarity.

17. A communication control device that performs a communication process among a plurality of devices including a first device and a second device that perform communication to a bus through an auxiliary device, the devices performing communication using the communication process, wherein the first device is an idle state when a transmission control terminal of the first device is set to a first polarity and a data output terminal of the first device is set to a second polarity different from the first polarity, the communication control device comprising:
a polarity changing unit that changes the transmission control terminal from the first polarity to the second polarity if there is data to be transmitted from the first device to the second device;
a transistor controlling unit that turns on a transistor in the auxiliary device in response to the change of the transmission control terminal; and
a transmitting unit that transmits the data from the first device to the second device via the transistor in the auxiliary device after changing the data output terminal of the first device from the second polarity to the first polarity.
